(19) United States
(12) Patent Application Publication
(10) Pub. No.: US 2009/0205374 A1
(43) Pub. Date: Aug. 20, 2009

(54) Method and Apparatus for the Production of Optical Fibers With Reduced Polarization Mode Dispersion

(76) Inventors: Roberto Pata, Milano (IT); Giacomo Stefano Roba, Milano (IT); Davide Sarchi, Milano (IT); Marco Tedeschi, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/086,689

(22) PCT Filed: Dec. 23, 2005
(86) PCT No.: PCT/EP2005/013998

§ 371 Date: Jun. 18, 2008

(51) Int. Cl. C03B 37/02

(52) U.S. Cl. 65/402; 65/504

(57) ABSTRACT

A method and apparatus for manufacturing an optical fiber includes the steps and/or means of: drawing a fiber from a heated preform by applying a pulling force to the fiber; spinning the fiber while it is drawn, wherein the step of spinning the fiber includes the sub-steps of winding the fiber on a spin roller by a winding arc, such that a friction force is generated between the fiber and the spin roller resulting from the winding arc and from the pulling force; axially displacing the spin roller such that the fiber is caused to roll over the spin roller surface by the friction force.

The present invention relates to a method and an apparatus for the production of optical fibers.

A light travelling in an optical fiber has two polarization modes. For optical fibers that are perfectly circularly symmetric in both geometry and internal and applied stress, operation at a wavelength or in a wavelength range which is regarded as “single-moded” actually supports two orthogonal polarization modes wherein the two polarization modes are degenerate, propagating at the same group velocity and with no time delay after travelling the same distance in the fiber.

In practical single mode fibre, various imperfections such as asymmetrical lateral stress and a non-circular core typically break the circular symmetry of the ideal fiber. As a result, the two polarization modes propagate with different propagation constants. The difference between the propagation constants is termed birefringence, the magnitude of the birefringence being given by the difference in the propagation constants of the two orthogonal modes.

Birefringence causes the polarization state of light propagating in the fiber to evolve periodically along the length of the fiber. In addition to causing periodic changes in the polarization state of light travelling in a fiber, the presence of birefringence means that the two polarization modes travel at different group velocities, the difference increasing as the birefringence increases. The differential time delay between the two polarization modes is called Polarization Mode Dispersion (PMD).

PMD causes signal distortion, thus is detrimental in high bit rate and analog communication systems.

PMD can be reduced by spinning the fiber.

To the purpose of the present description and claims, by fiber spinning we mean applying a torsion along the axis of the optical fiber; more in particular, unless differently specified, in the present description and claim by fiber spinning we mean a torsion applied alternatively in opposite directions (“alternate spinning”), i.e. the fiber has some turns in one direction followed by some turns in the opposite direction. Preferably, when such alternate spinning is applied, the overall torsion in the resulting fiber is generally null, or has a very small value.

During the spinning process, a fiber undergoes an axial rotation in one direction from zero to the maximum rotation value (spin/m), remains at such maximum rotation value and then decreases the rotation down to zero and further to a negative rotation value, i.e. rotation in the opposite direction.

The function by which such rotation varies in time is called spin function

The applied spin function and the obtained spin function typically differ, depending on various factors of the process and of the used apparatus, which include, for example, the type of applied spin function, the features of the spinning apparatus, e.g. possible fiber slippage or the like may take place, the overall responsiveness of the drawing tower etc.

U.S. Pat. No. 5,298,047 discloses a method of making optical fiber, typically single mode fiber, that can be used to produce fiber having low PMD. The method comprises providing a conventional optical fiber preform, heating at least a portion of the preform to a conventional draw temperature, and drawing optical fiber from the heated preform in such a way that a spin is impressed on the fiber. A spin is “impressed” on the fiber herein if fiber material in the hot zone is caused to be torsionally deformed, with the deformation being frozen into the fiber, such that the fiber exhibits a permanent “spin”, i.e., a permanent torsional deformation.

EP 0 785 913 discloses a method wherein a torque is applied to a fiber by running the fiber itself between a pair of wheels which rotate in mutually opposite senses and are displaced back and forth relative one another in a direction substantially perpendicular to the direction of displacement of the fiber through the wheels; the wheels are arranged in such a way that the fiber runs substantially tangential to the curved surface of the wheels themselves and is pressed therebetween in order to obtain the frictional force necessary to transmit the torque and obtain the twisting action.

According to this document, the pressing action exerted on the fiber to be spinned should be only to ensure that the fiber is rolled between the wheels, without fiber slip. The pressing is to be controlled so to avoid an excess causing mechanic stress on the fiber.

However, the Applicant observed that when spinning is applied to a fiber by pressing the same fiber between two rollers, the applied pressure is a critical parameter, in that an excessive pressure causes damages to the optical fiber, while lower pressure values progressively cause fiber slippage which results into a spin in the fiber significantly different from the applied spin, with poor reproducibility in an industrial process.

In particular, the Applicant noticed that a drawing/spinning process effected by pressing the optical fiber between the rollers often resulted in an optical fiber provided with a spin function not constant along the length thereof and not constant for subsequent fibers produced with the same spinning parameters.

Within the present invention the Applicant perceived that an effective spinning can be reproducibly applied to the fiber, without pressing the fiber between two rollers, if the friction required to cause the desired rolling of the fiber is obtained by extending the contact surface between the fiber and the roller beyond the point-like contact obtained in case of tangential contact of the fiber with the rollers.

In particular, the Applicant found that a spinning apparatus and process in which the fiber to be spun is wound by a given arc around at least one spin roller, preferably two spin rollers, spaced apart of a distance greater than the optical fiber diameter provide an optical fiber with a spin value significantly more constant along the optical fiber than that obtained with the prior art methods, without causing any significant damage to the optical fiber.

For the purpose of the present description and of the claims that follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

In a first aspect, the present invention relates to a method for manufacturing an optical fiber comprising the steps of
drawing a fiber from a heated preform, by applying a pulling force to the fiber;
spinning the fiber while it is drawn,
   wherein the step of spinning the fiber comprises the sub-steps of
winding the fiber on a spin roller by a winding arc, such that a friction force is generated between the fiber and the spin roller resulting from said winding arc and from said pulling force;
axially displacing said spin roller such that the fiber is caused to roll over the spin roller surface by said friction force.

Preferably, the method for manufacturing an optical fiber comprises the steps of
drawing a fiber from a heated perform, by applying a pulling force to the fiber;
spinning the fiber while it is drawn,
   wherein the step of spinning the fiber comprises the sub-steps of
winding the fiber on a first spin roller by a first winding arc, such that a friction force is generated between the fiber and the first spin roller resulting from said first winding arc and from said pulling force;
winding the fiber on a second spin roller by a second winding arc, such that a friction force is generated between the fiber and the second spin roller resulting from said second winding arc and from said pulling force, the first and second spin rollers being by opposite sides with respect to the fiber;
axially displacing said first spin roller and said second spin roller one relative to the other such that the fiber is caused to roll over the first and second spin roller surfaces by said friction force.

Preferably, said first spin roller and said second spin roller are displaced in opposite directions.

In a preferred embodiment, the method of the present invention further comprises the step of guiding the fiber on a vertical plane perpendicular to the spin roller axis, at least before the step of winding the fiber on a spin roller.

In particular, the step of guiding the fiber in a vertical plane perpendicular to the spin roller axis includes causing the fiber to pass between a pair of guiding rollers.

More preferably the method of the present invention comprises the step of guiding the fiber in a vertical plane perpendicular to the spin roller axis both before and after the step of winding the fiber on a spin roller.

In a second aspect, the present invention relates to an apparatus for spinning an optical fiber drawn in a drawing direction, comprising
a first and second parallel spin rollers having substantially cylindrical outer surfaces, said spin rollers being
   spaced apart from each other along said drawing direction,
   at least partly overlapping along said drawing direction, so as to cause a fiber drawn therethrough to form a winding arc over the outer surface of at least one of said spin rollers;
   forming a gap between their outer surfaces greater than the optical fiber outer diameter; and
a reciprocating mechanism operatively connected to said spin rollers for the axial, alternate displacement thereof.

Preferably, the axes of said parallel spin rollers have axes laying in a common plane forming an angle (α₁) with respect to the plane orthogonal to the drawing direction.

Preferably, the angle α₁ has a value of from 25° to 35°, more preferably of from 27 to 31°.

Preferably, said winding arc has an extension of from 1.5% to 5% of the circumference of the spin roller.

Preferably, the gap between the spin rollers of the apparatus of the invention is from 1.5 to 2.5 mm wide, more preferably from 1.9 to 2.1 mm wide.

In a preferred embodiment, the apparatus of the present invention comprises at least one pair of parallel guide rollers with axes laying in horizontal planes and perpendicular to the axes of said spin rollers.

More preferably, the apparatus of the present invention comprises two pairs of guide rollers respectively upstream and downstream to the couple of spin rollers.

Preferably, the surface of the spin rollers is coated by a friction coefficient enhancer coating, for example by rubber.

Preferably, the spin rollers are supported, by means of rotation spindles, to respective pivotable frames.

Advantageously, said pivotable frames are supported by props, by means of relevant pivot spindles.

Advantageously, said props are fixed on sledges each movable, e.g. along a pair of tracks. Preferably, said tracks are parallel to the rotation axes of the rotation spindles of the spinner rollers.

The pairs of tracks can be secured to a main base.

Advantageously, said main base is secured on a drawing tower.

Preferably, said main base has an aperture. In a more preferred embodiment, said aperture has an elongated shape, for example rectangular, with a major side parallel to the rotation axes of the rotation spindles of the spin rollers.

Advantageously, said major side of the aperture has length such to allow the fiber to move substantially freely while the spin rollers are traversed.

In a preferred embodiment, the apparatus of the invention comprises a position adjusting apparatus, adjustable to set the distance of the spin rollers one from the other.

Optionally, one of the spin rollers is fixed to the main base.

In a preferred embodiment of the apparatus of the invention, the sledges bearing the spin rollers are operatively connected to the reciprocating mechanism.

Preferably, the reciprocating mechanism comprises at least two connecting elements, each for one of the sledges, linking the sledges to an engine in such a manner to actuate the sledge to move alternate one another.

Further details may be obtained from the following description of a non-limiting example of embodiment of the subject of the present invention provided with reference to the accompanying drawings in which:

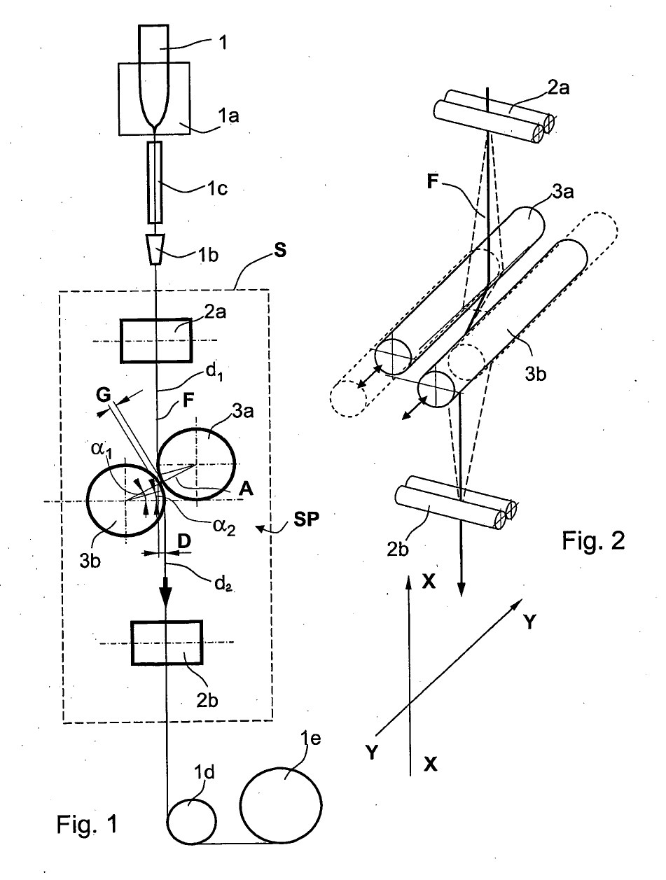

FIG. 1: shows a schematic view of the fiber drawing line, including the spinning apparatus performing the method according to the present invention;

FIG. 2: shows a schematic perspective view of the spinning apparatus according to the present invention, with an optical fiber running therethrough;

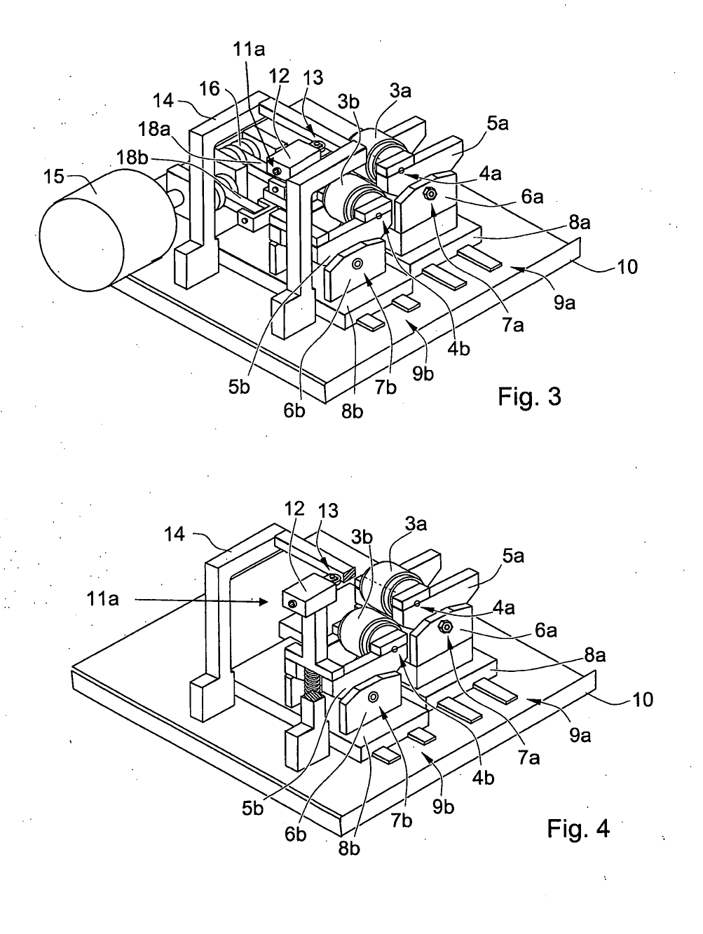

FIG. 3: shows a schematic perspective view of a preferred embodiment of a spinning apparatus according to the present invention;

FIG. 4: shows a perspective view, partially in cross-section of the spinning apparatus of FIG. 4;

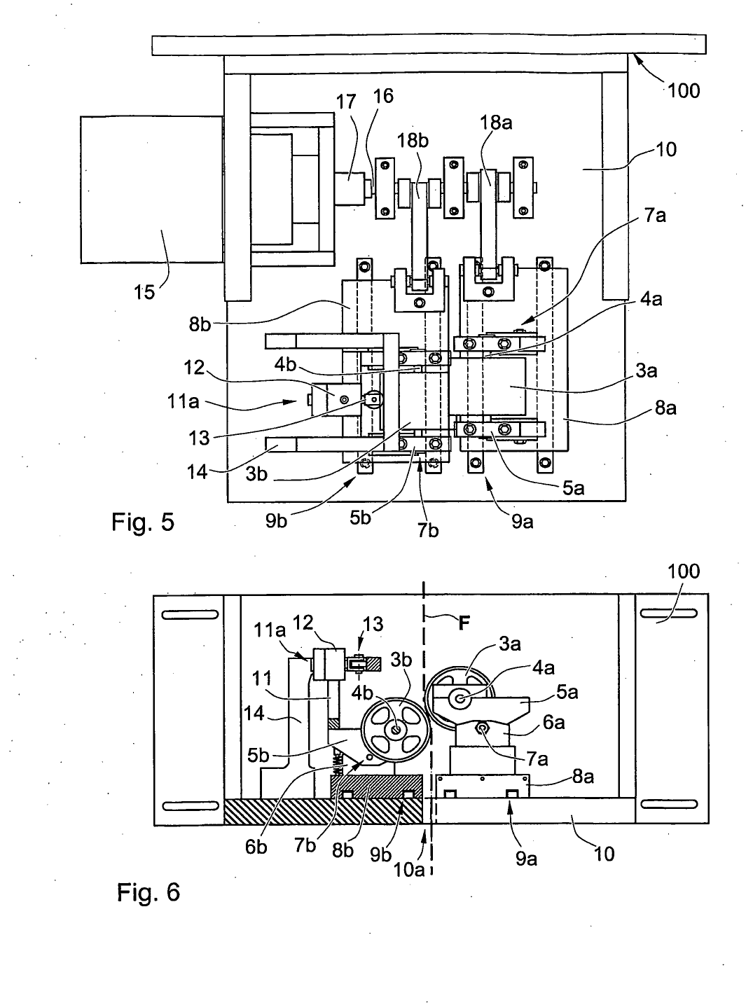

FIG. 5: shows a top view of the spinner of FIG. 4;

FIG. 6: shows a side view partially in cross-section of the spinner of FIG. 4;

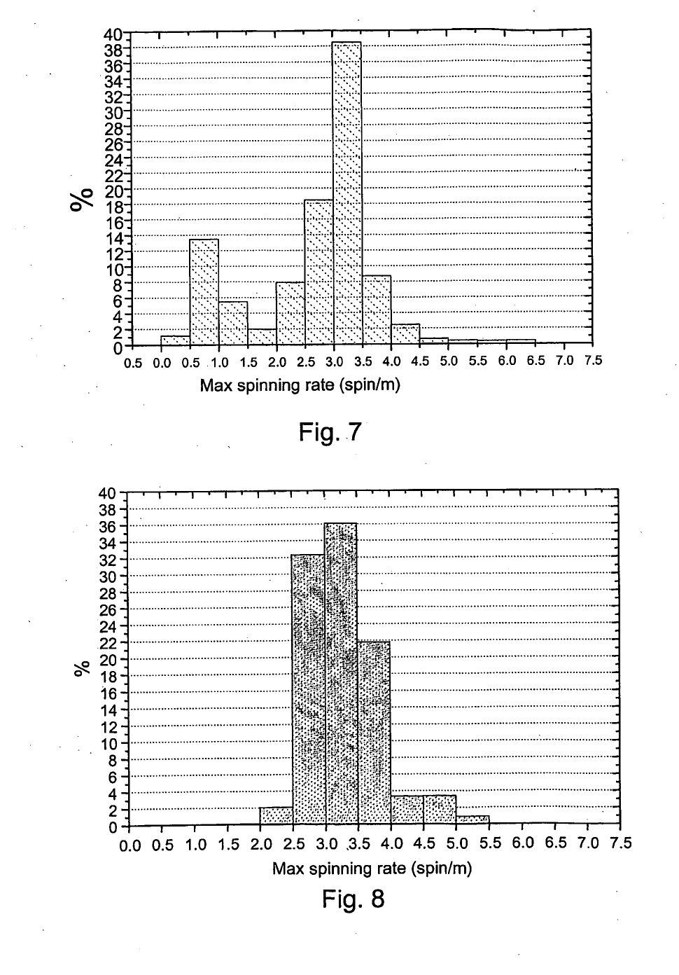

FIG. 7: shows the maximum spin distribution in production as obtained with a spinning apparatus and method according to the prior art;

FIG. 8: shows the maximum spin distribution in production as obtained with a spinning apparatus and method according to the present invention.

FIG. 1 shows a schematic view of a fiber drawing line. A fiber is drawn along a direction Y-Y, that is generally vertical. A direction X-X, orthogonal to the drawing direction, is also shown.

If not otherwise specified, in the following the drawing direction Y-Y will be considered as vertical.

An optical fiber F is drawn from a preform 1, heated up to a molten or softened state by a furnace 1a.

After having been drawn, the fiber is cooled by a cooling device 1c and, thereafter, it is coated by a coating device 1b provided along the typically vertical path along which the fiber is drawn.

The coated fiber F subsequently enters the spinner S.

After the spinner S, the fiber is pulled by a pulling device 1d, such as a capstan, a pulling roller, a tractor belt or the like, which ensures that the fiber is drawn at a linear velocity VF.

The spinner S, comprises a first couple of guide rollers 2a, positioned upstream a spinning apparatus SP and a second couple of guide rollers 2b positioned downstream said spinning device.

The spinning apparatus SP comprises a couple of parallel spin rollers, 3a, 3b with respective rotation axes laying in a common plane A forming an angle α₁ see FIG. 1 with the plane orthogonal to the longitudinal axis along which the optical fiber is drawn.

In an example, the angle α₁ is set to a value of about 29°. Typically, such angle is comprised in the range of 25-35°, preferably between 27-31°.

In such example, the spin rollers 3a, 3b have a radius of 25 mm and a length of 40 mm. The axes of the spin rollers 3a, 3b are spaced apart from each other by 52 mm, thereby leaving a gap G 2 mm wide, that means a gap G about 8 times larger than the coated optical fiber diameter.

As the gap G between the spin rollers 3a, 3b is significantly wider than the diameter of the coated fiber, typically of about 250 μm the latter is never pressed between the rollers, thereby avoiding fiber damage and minimizing wear and tear of the rollers.

The spin rollers 3a, 3b are free to rotate about their axes, with minimum friction.

When a fiber is drawn through said spin rollers 3a, 3b, it drives the spin rollers in rotation in opposite directions, that means that when a spin roller rotates clockwise the other rotates counterclockwise. The spin rollers 3a, 3b are supported by respective frames connected to a reciprocating mechanism, by which they are axially displaced back and forth, in opposition of phase to each other, as better described in the following.

In the described exemplary embodiment, a stroke of 10 mm is applied to obtain about twelve fiber turns before reversal. Conveniently, the apparatus allows the stroke to be adjusted for different spin functions.

In operation, the drawn fiber F contacts the outer surface of the upper spin roller 3a and winds around such roller by an arc, contacts the outer surface of the lower spin roller 3b and winds around such roller by an arc, then continues along a drawing line parallel and slightly offset with the previous one. With the given geometry, the fiber winds on the surface of each spin roller 3a, 3b by an arc α₂ of about 13°, corresponding to a circumferential length of about 5.7 mm, i.e. about 3.5% of the roller circumference.

Because of the winding around the spin rollers 3a, 3b the fiber drawing line d₂ downstream the spin roller 3b is offset by a distance D of about 4.5 mm with respect to the fiber drawing line d₁ upstream the spin roller 3a.

Upstream and downstream the spin rollers 3a, 3b two pairs of parallel guide rollers 2a, 2b are arranged respectively, with their axes perpendicular to the axes of the spin rollers 3a, 3b and laying in planes perpendicular to the drawing line typically horizontal, (as apparent in the perspective view of FIG. 2).

The rollers of each pair of guide rollers 2a, 2b are spaced from one another by about 1 mm and are arranged so that the fiber passes between them, as shown in FIG. 2.

The pairs of guide rollers 2a, 2b are freely rotating around their axes and are supported by relevant frames, (not shown), so that their axes remain fixed with respect to the whole drawing tower.

In the described embodiment, the plane of the axes of the upper pair of guide rollers 2a is 140 mm over the axis of the upper spin roller 3a and the plane of the axes of the lower pair of guide rollers 2b is 170 mm below the axis of the lower spin roller 3b.

The pairs of guide rollers 2a, 2b are aligned so that the fiber passing through the 1 mm gap between them substantially lies in the same vertical plane upstream and downstream the pairs of rollers.

The pairs of rollers 2a, 2b have the function of stopping the deviation caused by the movement of the spin rollers 3a, 3b, thereby maintaining the fiber aligned in a common vertical plane upstream and down-stream of the spinner S and preventing possible propagation of vibrations along the fiber.

For example, the pair of guide rollers 2a, 2b are made of aluminum; they are cylindrical, with smooth surface.

During operation the fiber is drawn between the spin rollers 3a, 3b and contacts them in sequence. As the rollers are axially displaced, the drawn fiber rolls over the surfaces of the spin rollers 3a, 3b because of the friction caused by the fiber pulling force and the winding length of the fiber around the rollers.

The axial displacement of the spin rollers 3a, 3b also causes a lateral drag on the fiber in addition to rolling it and this results in deviation of the fiber from the vertical drawing line Y-Y, as shown in FIG. 2. For example, in the tested embodiment, the amount of deviation is of 2.5 mm, corresponding to about 25% of the roller stroke for an examplary process at a frequency of 3.8 Hz, drawing speed of 18 m/s, and 100 g of drawing tension.

A preferred embodiment of the spinning apparatus SP according to the present invention is shown in FIGS. 3 to 6 wherein the two pairs of parallel guide rollers 2a, 2b are omitted for sake of simplicity.

The spin rollers 3a, 3b are supported, by means of rotation spindles 4a, 4b, to respective pivotal frames 5a, 5b that are, in turn, supported by props 6a, 6b by means of respective pivot spindles 7a, 7b.

In turn, props 6a, 6b are fixed on sledges 8a, 8b each movable along a pair of tracks 9a, 9b, said tracks 9a, 9b being parallel to the rotation axes of the rotation spindles 4a, 4b of the spin rollers 3a, 3b.

The pairs of tracks 9a, 9b are secured to a main base 10.

The main base 10, together with a scaffold 100, (FIG. 5) is used to keep part of the spinning apparatus shown in FIG. 3-6 secured on the drawing tower.

The main base 10 has an aperture 10a of substantially rectangular shape with the major side parallel to rotation axes of the rotation spindles 4a,4b of the spin rollers 3a,3b. The major side of the aperture 10a has length suitable to allow the fiber to move freely while the spinner rollers 3a,3b are traversed moving along the pairs of tracks 9a,9b as explained in further details here below.

The apparatus comprises a position adjusting apparatus, for example as described in the following.

A T-stem 11 projects upward from the frame 5b. The T-stem 11 bears on the top thereof the block 12 that holds a small wheel 13 with axis perpendicular to the rotation spindles 4a,4b. The position of the small wheel 13 with respect to the block 12 can be adjusted by a screw 11a.

The small wheel 13 contacts a U-shaped frame 14 projecting upward from the main base 10.

By rotating the screw 11a, the small wheel 13 is moved, e.g., toward or from the U-shaped frame 14 and, as a consequence, the spin roller 3b is moved displaced with respect to the spin roller 3a.

Such a movement can be useful either for adjusting the relative position of the spin rollers 3a,3b, and/or for facilitating the insertion of an optical fiber through the aperture 10a before starting the drawing/spinning process.

In the embodiment depicted by FIGS. 3-6, the frame 5a bearing the spin roller 3a is be fixed; in alternative, if needed, also the position of the frame 5a and of the spin roller 3a can be made adjustable, either once, for example in connection with the apparatus setup, or at the beginning of the drawing or even during the operation.

In FIGS. 3 and 5, an engine 15 is shown. The engine 15 actuates a crankshaft 16 by means of a connector 17. The crankshaft 16 bears two rods 18a,18b connected, respectively, to the sledges 8a,8b.

While rotating, the crankshaft 16 and the two rods 18a,18b cause the sledges 8a,8b—and all the pieces supported thereupon—to move in a manner alternate one another along the respective pairs of tracks 9a,9b.

### EXAMPLE

The apparatus and method of the present invention were compared with an apparatus using rollers making the spinning action by pressing the optical fiber between them. Ten fiber drawing/spinning processes were carried out by using the pressing roller apparatus and, and ten by using the spinner apparatus according to the present invention. Each process was carried out with a preform yielding a 200 km-long optical fiber

The spin value applied to each fiber was measured by a fiber spin monitor FSM reading such value in continuous during the process, located just below the drawing furnace. It must be observed that, because of many effects associated with the fiber drawing and coiling process, such as the elastic recovery of the fiber torsion, slippages etc, the detected spin/value may not that of the fiber on the reel.

The results of the drawing/spinning process according to the prior art and those according to the present invention are shown in FIGS. 7 and 8, respectively, which represent

The stroke of the spin rollers was of 10 mm and the reversal frequency thereof of 4 Hz. The drawing speed was of 18 m/s.

As shown by the graph of FIG. 7, the detected maximum spin rate, i.e. the amount of spin that the apparatus was able to transfer into the fiber, was distributed in a broad range, such that about 66% of length of the obtained optical fibers had a spin value of 2.5□4 spin/m range. A significant percentage of the spun optical fibers length (about 19%) had a maximum spin value in the range of 0.5□2.0 spin/m, and about 8% had a maximum spin value between 2 and 2.5 spin/m. Low percentages of maximum spinning values higher than 4 spin/m, up to 6.5 spin/m were also measured.

As appears from FIG. 8, the spinning/drawing process according to the present invention provided optical fibers with a production distribution in which:
about 36% of the length was spun at 3.0□3.5 spin/m;
about 32% of the length was spun at 2.5□3.0 spin/m;
about 22% of the length was spun at 3.5□4.0 spin/m;

Accordingly, about 90% of the length of the optical fibers obtained according to the present invention art had a maximum spin value comprised in the range of 2.5□4 spin/m. Spin values higher than 4 spin/m were less than 8%; Spin values lower than 2.0 spin/m and higher than 5.5 spin/m were absent.

The results above confirm that the spinning apparatus and process according to the present invention provides optical fibers with spin value significantly more constant along the fiber length than the fibers produced with a spinning apparatus with rollers pressed one against the other.

The lack of compression of the fiber allows to reduce the risks of mechanical damages or slip of the fiber during the spinning step with respect to the prior art and the reliability of the method and the repeatability of the spin parameters of the obtained fibers is increased.

The geometrical values and process parameters given in the examples above have provided satisfactory results in the applied conditions; in different conditions, different drawing tower etc., these values and parameters could be adjusted to optimize the operation. In particular the ability of the spinner to provide sufficient friction to rotate the optical fiber as required can be adjusted by adjusting the arc by which the fiber is wound around the spin rollers, without any need to press the fiber between spin rollers or to modify other drawing parameters (e.g the pulling force) which may otherwise affect the drawing process and the resulting fiber.

1-30. (canceled)

31. A method for manufacturing an optical fiber, comprising the steps of:
drawing a fiber from a heated preform by applying a pulling force to the fiber; and
spinning the fiber while it is drawn,
wherein the step of spinning the fiber comprises the sub-steps of:
winding the fiber on a spin roller by a winding arc such that a friction force is generated between the fiber and the spin roller resulting from said winding arc and from said pulling force; and
axially displacing said spin roller such that the fiber is caused to roll over the spin roller surface by said friction force.

32. The method according to claim 31, comprising the steps of:
drawing a fiber from a heated preform by applying a pulling force to the fiber; and
spinning the fiber while it is drawn,
wherein the step of spinning the fiber comprises the sub-steps of:
winding the fiber on a first spin roller by a first winding arc such that a friction force is generated between the fiber and the first spin roller resulting from said first winding arc and from said pulling force;
winding the fiber on a second spin roller by a second winding arc such that a friction force is generated between the fiber and the second spin roller resulting from said second winding arc and from said pulling force, the first and second spin rollers being on opposite sides with respect to the fiber; and
axially displacing said first spin roller and said second spin roller one relative to the other such that the fiber is caused to roll over the first and second spin roller surfaces by said friction force.

33. The method according to claim 32, wherein said first spin roller and said second spin roller are displaced in opposite directions.

34. The method according to claim 31, comprising the step of guiding the fiber on a vertical plane perpendicular to the spin roller axis, at least before the step of winding the fiber on a spin roller.

35. The method according to claim 34, wherein the step of guiding the fiber in a vertical plane perpendicular to the spin roller axis, comprises causing the fiber to pass between a pair of guiding rollers.

36. The method according to claim 34, comprising the step of guiding the fiber in a vertical plane perpendicular to the spin roller axis both before and after the step of winding the fiber on a spin roller.

37. An apparatus for spinning an optical fiber drawn in a drawing direction, comprising:
a first and a second parallel spin roller having substantially cylindrical outer surfaces, said spin rollers:
being spaced apart from each other along said drawing direction;
being at least partly overlapping along said drawing direction, so as to cause a fiber drawn therethrough to form a winding arc over the outer surface of at least one of said spin rollers;
forming a gap between outer surfaces thereof greater than the optical fiber outer diameter; and
a reciprocating mechanism operatively connected to said spin rollers for the axial, alternate displacement thereof.

38. The apparatus according to claim 37, wherein said parallel spin rollers have axes laying in a common plane forming an angle with respect to the plane orthogonal to the drawing direction.

39. The apparatus according to claim 38, wherein the angle is 25° to 35°.

40. The apparatus according to claim 39, wherein the angle is 27° to 31°.

41. The apparatus according to claim 37, wherein said winding arc has an extension of 1.5% to 5% of the circumference of the spin roller.

42. The apparatus according to claim 37, wherein the gap between the spin rollers is 1.5 to 2.5 mm wide.

43. The apparatus according to claim 42, wherein the gap between the spin rollers is 1.9 to 2.1 mm wide.

44. The apparatus according to claim 37, comprising at least one pair of parallel guide rollers with axes laying in horizontal planes and perpendicular to the axes of said spin rollers.

45. The apparatus according to claim 44, comprising two pair of guide rollers respectively upstream and downstream to a couple of spin rollers.

46. The apparatus according to claim 37, wherein the surface of the spin rollers is coated by a friction coefficient enhancer coating.

47. The apparatus according to claim 37, wherein the spin rollers are supported, by means of rotation spindles to respective pivotable frames.

48. The apparatus according to claim 47, wherein said pivotable frames are supported by props by means of relevant pivot spindles.

49. The apparatus according to claim 48, wherein said props are fixed on sledges.

50. The apparatus according to claim 49, wherein said sledges are movable along a pair of tracks.

51. The apparatus according to claim 50, wherein said tracks are parallel to rotation axes of the rotation spindles of the spin rollers.

52. The apparatus according to claim 50, wherein the pair of tracks is secured to a main base.

53. The apparatus according to claim 52, wherein said main base is secured on a drawing tower.

54. The apparatus according to claim 52, wherein said main base has an aperture.

55. The apparatus according to claim 54, wherein said aperture has an elongated shape with a major side parallel to rotation axes of the rotation spindles of the spin rollers.

56. The apparatus according to claim 55, wherein said major side of the aperture has length to allow the fiber to move substantially freely while the spin rollers are traversed.

57. The apparatus according to claim 37, comprising a position adjusting apparatus.

58. The apparatus according to claim 52, wherein one of the spin rollers is fixed to the main base.

59. The apparatus according to claim 49, wherein the sledges are operatively connected to the reciprocating mechanism.

60. The apparatus according to claim 49, wherein the reciprocating mechanism comprises at least two connecting elements, each connecting element for one of the sledges, linking the sledges to an engine.
